(19) United States
(12) Patent Application Publication
(10) Pub. No.: US 2025/0294107 A1
(43) Pub. Date: Sep. 18, 2025

(54) INFORMATION PROCESSING SYSTEM AND NON-TRANSITORY COMPUTER-READABLE STORAGE MEDIUM STORING INFORMATION PROCESSING PROGRAM

(71) Applicant: FUJIFILM Business Innovation Corp., Tokyo (JP)

(72) Inventor: Takahiro NAKAMURA, Kanagawa (JP)

(73) Assignee: FUJIFILM Business Innovation Corp., Tokyo (JP)

(21) Appl. No.: 18/785,990

(22) Filed: Jul. 26, 2024

(30) Foreign Application Priority Data
Mar. 13, 2024 (JP) 2024-038928

(51) Int. Cl. H04N 1/00

(52) U.S. Cl. CPC H04N 1/00925; H04N 1/00973

(57) ABSTRACT

An information processing system includes a processor, in which when the processor has received an operation request from a user for an operation of an image processing apparatus without operation authority, the processor transmits approval request information for the operation request to an operation terminal of the image processing apparatus determined based on an operation history of the image processing apparatus.

### CROSS-REFERENCE TO RELATED APPLICATIONS

This application is based on and claims priority under 35 USC 119 from Japanese Patent Application No. 2024-038928 filed Mar. 13, 2024.

### BACKGROUND

### (i) Technical Field

The present invention relates to an information processing system and a non-transitory computer-readable storage medium storing the information processing program.

### (ii) Related Art

JP2021-051552A discloses an information processing apparatus including a memory and a processor, wherein the processor issues, based on an operation from a first user having administrator authority in a first system, temporary authentication information associated with a first account specified by the first user, and when a second user who uses a second system presents temporary authentication information and requests cooperation with the first system and the issued temporary authentication information matches the presented temporary authentication information, associates the first account associated with the temporary authentication information with a second account specified by the second user.

JP2012-198828A discloses an image forming apparatus that performs processing on prestored data in accordance with an operation performed by an authenticated user, including a user authentication unit that authenticates a second user in a state where a first user is authenticated and has logged in, an access control unit that permits processing on user data to which one of the first user and the second user, the one of the first user and the second user being defined in advance by a login rank, is granted access authority in a login state where the first and second user have both been authenticated, and an operation control unit that receives an operation related to user data within a range of authority corresponding to at least one of operation authority given to the first user in advance and operation authority given to the second user in advance in the login state.

### SUMMARY

Aspects of non-limiting embodiments of the present disclosure relate to enabling an approval of an operation request from a user for an operation of an image processing apparatus without operation authority even when a specific approver is not present.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a processor, wherein when the processor has received an operation request from a user for an operation of an image processing apparatus without operation authority, the processor transmits approval request information for the operation request to an operation terminal of the image processing apparatus determined based on an operation history of the image processing apparatus.

### BRIEF DESCRIPTION OF THE DRAWINGS

Exemplary embodiments of the present invention will be described in detail based on the following figures, wherein:

FIG. 1 is a diagram illustrating a schematic configuration of an image forming system according to an exemplary embodiment;

FIG. 2 is a block diagram illustrating a hardware configuration of the image processing apparatus illustrated in FIG. 1;

FIG. 3 is a block diagram illustrating a hardware configuration of an operation terminal illustrated in FIG. 1;

FIG. 4 is a functional block diagram of the image processing apparatus and the operation terminal illustrated in FIG. 1;

FIG. 5 is a diagram illustrating an example of an operation history table of the image processing apparatus illustrated in FIG. 1;

FIG. 6 is a diagram illustrating an example of a temporary user management table of the image processing apparatus illustrated in FIG. 1;

FIG. 7 is a flowchart illustrating a flow of approval request processing of the image forming apparatus illustrated in FIG. 1;

FIG. 8 is a flowchart illustrating a flow of approval processing of the operation terminal illustrated in FIG. 1;

FIG. 9 is a diagram illustrating an example of a selection screen of the operation terminal illustrated in FIG. 1;

FIG. 10 is a diagram illustrating an example of an approval screen of the operation terminal illustrated in FIG. 1; and

FIG. 11 is a diagram illustrating an example of the approval screen of the operation terminal illustrated in FIG. 1.

### DETAILED DESCRIPTION

Hereinafter, an exemplary embodiment will be described with reference to the drawings. In the drawings, the same or equivalent constituent elements and parts are denoted by the same reference numerals. The dimensional ratios in the drawings are exaggerated for convenience of description and may be different from the actual ratio.

### (Outline of Image Processing System)

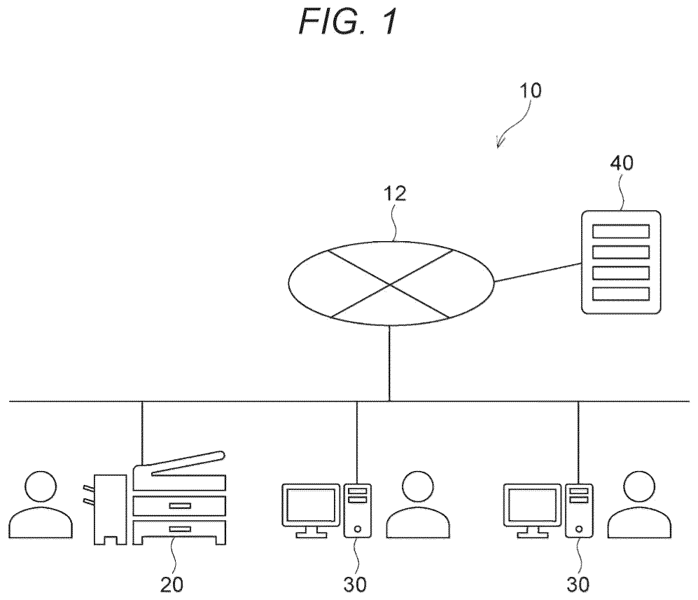

FIG. 1 illustrates an image processing system 10 according to the exemplary embodiment. The image processing system 10 includes an image processing apparatus 20, a plurality of operation terminals 30, and a management server 40. The image processing apparatus 20, the plurality of operation terminals 30, and the management server 40 are connected to a network 12.

The network 12 is an internal network such as a local area network (LAN) or a wide area network (WAN), or an external network such as the Internet. The image processing apparatus 20, the plurality of operation terminals 30, and the management server 40 are communicably connected to each other via the network 12.

Simple Network Management Protocol (SNMP) is implemented in the image processing apparatus 20, the plurality of operation terminals 30, and the management server 40. More specifically, SNMP version 3 (SNMPv3) is implemented in the image processing apparatus 20, the plurality of operation terminals 30, and the management server 40. Each operation terminal 30 and the management server 40 can acquire various kinds of information from a management information base (MIB) of the image processing apparatus 20 in accordance with SNMPv3.

In SNMPv3, authentication with an authentication protocol is enabled. Examples of the authentication protocol include Message Digest Algorithm 5 (MD5) and Secure Hash Algorithm (SHA). In SNMPv3, encrypted communication (encryption of messages) is enabled. Examples of the encrypted communication include Data Encryption Standard (DES) and Advanced Encryption Standard (AES).

Not only SNMPv3 but also SNMP version 1 (SNMPv1) and SNMP version 2c (SNMPv2c) may be implemented in the image processing apparatus 20 and the plurality of operation terminals 30. However, authentication with an authentication protocol and encrypted communication are not provided in SNMPv1 or SNMPv2c.

The image processing apparatus 20 and the operation terminal 30 are examples of an information processing apparatus and an information processing system. Here, the “system” in the exemplary embodiment is a concept including both a system configured by a plurality of devices and a system configured by a single device. FIG. 1 illustrates one image processing apparatus 20 as an example. However, a plurality of image processing apparatuses 20 may be provided.

### (Image Processing Apparatus)

The image processing apparatus 20 is, as an example, a printing apparatus on the network 12 having an image printing function of acquiring image data from the operation terminal 30 and printing the acquired image data on a recording medium such as paper. The image processing apparatus 20 may be, for example, a multifunction machine having at least one of a plurality of functions such as an image reading (scanning) function, an image copying function, and an image transmitting (facsimile) function, in addition to the above-described image printing function.

### (Operation Terminal)

The operation terminal 30 is, as an example, an information processing terminal operated by a user who uses the image processing apparatus 20. The operation terminal 30 is a personal computer, a notebook computer, a smartphone, or the like.

### (Management Server)

The management server 40 is, as an example, a server that manages the user of each operation terminal 30 and the user of the image processing apparatus 20. Specifically, the management server 40 includes a user management table (not illustrated) in which authentication information such as a user ID and a password given to the users of the image processing apparatus 20 and the operation terminal 30 is registered.

In response to a request from the image processing apparatus 20, the management server 40 performs user authentication processing for the image processing apparatus 20 and transmits an authentication result to the image processing apparatus 20. Specifically, the management server 40 collates the user ID and the password of the user received from the image processing apparatus 20 with the user ID and the password registered in the user management table. When the user ID and the password of the user received from the image processing apparatus 20 are present in the user management table, the management server 40 determines that the authentication is successful, and transmits the authentication result to the image processing apparatus 20. On the other hand, when the user ID and the password of the user received from the image processing apparatus 20 are not present in the user management table, the management server 40 determines that the authentication has failed, and transmits the authentication result to the image processing apparatus 20.

In response to a request from the operation terminal 30, the management server 40 performs user authentication processing for the operation terminal 30, and transmits the authentication result to the operation terminal 30. Specifically, the management server 40 collates the user ID and the password of the user received from the operation terminal 30 with the user ID and the password registered in the user management table. When the user ID and the password of the user received from the operation terminal 30 are present in the user management table, the management server 40 determines that the authentication is successful, and transmits the authentication result to the operation terminal 30. On the other hand, when the user ID and the password of the user received from the operation terminal 30 are not present in the user management table, the management server 40 determines that the authentication has failed, and transmits the authentication result to the operation terminal 30.

The management server 40 manages the connection state of a user. In other words, the management server 40 manages the connection state of the operation terminal 30 operated (held) by the user. Specifically, the management server 40 distinguishes between an online (active) state indicating a state where the operation terminal 30 is connected to the management server 40 and an offline (inactive) state indicating a state where the operation terminal 30 is not connected to the management server 40 based on the access information or the like from the operation terminal 30, and stores it in association with the user. The management server 40 also updates the connection state of each operation terminal 30 as needed.

The management server 40 also manages the operation authority of the user for the image processing apparatus 20. Specifically, in the user management table, the operation authority for the image processing apparatus 20 is registered for each user. When the authentication processing of the user for the image processing apparatus 20 is successful, the management server 40 transmits the authentication result and the operation authority of the user to the image processing apparatus 20.

The authentication processing for the user for the image processing apparatus 20 and the management of the operation authority are not limited to the management server 40, and they may be performed by the image processing apparatus 20.

### (Hardware Configuration of Image Processing Apparatus)

Next, the hardware configuration of the image processing apparatus 20 will be described.

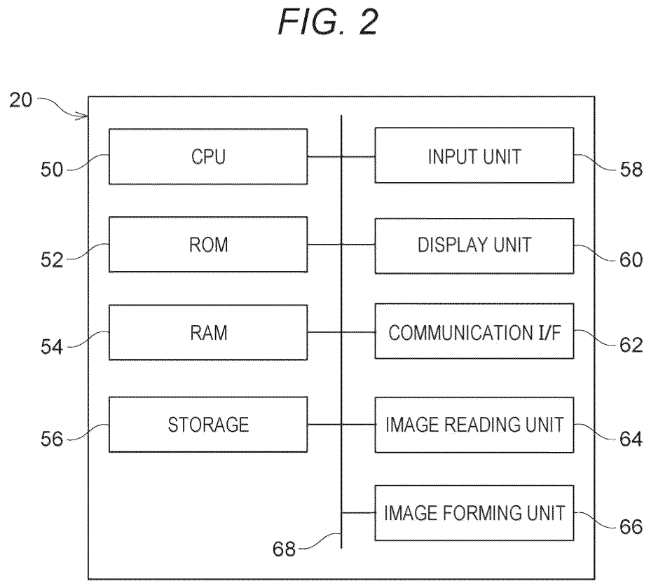

As illustrated in FIG. 2, the image processing apparatus 20 includes components of a central processing unit (CPU) 50, a read only memory (ROM) 52, a random access memory (RAM) 54, a storage 56, an input unit 58, a display unit 60, a communication interface (I/F) 62, an image reading unit 64, and an image forming unit 66. These components are communicably connected to each other via a bus 68.

The CPU 50 is a central processing unit, which executes various programs and controls each unit. That is, the CPU 50 reads a program from the ROM 52 or the storage 56 and executes the program using the RAM 54 as a working area. The CPU 50 controls the above-described components and performs various kinds of arithmetic processing in accordance with the program recorded in the ROM 52 or the storage 56. The CPU 50 is an example of a processor.

The ROM 52 stores various information processing programs and various kinds of data. The RAM 54 temporarily stores programs and data as a work area of the CPU 50.

The storage 56 is configured by a hard disk drive (HDD) or a solid state drive (SSD), and stores various programs including an operating system and various kinds of data. The storage 56 also stores a temporary approval request processing program.

The input unit 58 includes an operation button or the like, and is used to perform various inputs. The display unit 60 is, for example, a liquid crystal display, and displays various kinds of information. The display unit 60 may adopt a touch panel system to function as an input part.

The communication I/F 62 is an interface for communicating with other devices, and for example, a standard such as Ethernet (registered trademark), FDDI, or Wi-Fi (registered trademark) is used.

The image reading unit 64 optically reads image data from a document or the like. The image forming unit 66 prints image data read by the image reading unit 64 or image data received from the operation terminal 30 on a recording medium such as paper. The image reading unit 64 also functions as an input unit.

### (Hardware Configuration of Operation Terminal and Management Server)

Next, hardware configurations of the operation terminal 30 and the management server 40 will be described.

The operation terminal 30 and the management server 40 are configured by a typical computer or a server device. Thus, the hardware configuration of the operation terminal 30 will be described below, and a description of the hardware configuration of the management server 40 will be omitted as appropriate.

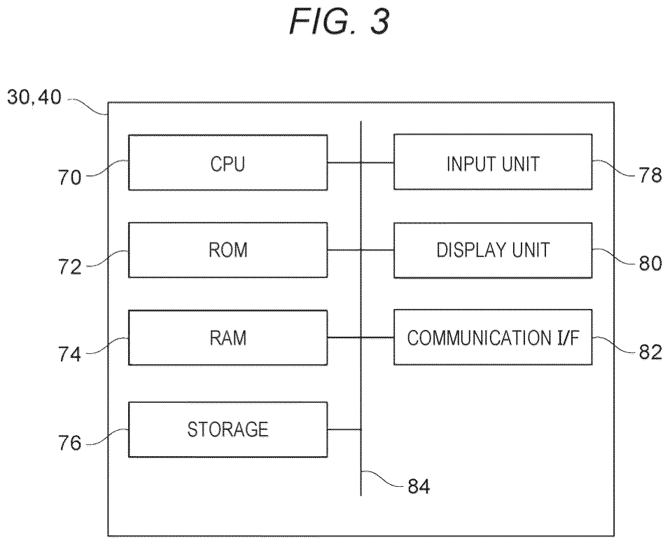

As illustrated in FIG. 3, the operation terminal 30 includes components of a CPU 70, a ROM 72, a RAM 74, a storage 76, an input unit 78, a display unit 80, and a communication interface (I/F) 82. These components are communicably connected to each other via a bus 84.

The CPU 70 is a central processing unit, which executes various programs and controls each unit. That is, the CPU 70 reads a program from the ROM 72 or the storage 76 and executes the program using the RAM 74 as a work area. The CPU 70 controls the above-described components and performs various kinds of arithmetic processing according to the program recorded in the ROM 72 or the storage 76. The CPU 70 is an example of a processor.

The ROM 72 stores various information processing programs and various kinds of data. The RAM 74 temporarily stores programs and data as a work area of the CPU 70.

The storage 76 includes an HDD or an SSD, and stores various programs including an operating system and various kinds of data. The storage 76 also stores a temporary approval processing program.

The input unit 78 includes a pointing device, such as a mouse, and a keyboard, and is used to perform various kinds of input. The display unit 80 is, for example, a liquid crystal display, and displays various kinds of information. The display unit 80 may adopt a touch panel system to function as an input part.

The communication I/F 82 is an interface for communicating with other devices, and for example, a standard such as Ethernet (registered trademark), FDDI, or Wi-Fi (registered trademark) is used.

### (Function of Image Processing Apparatus)

Next, the functions of the image processing apparatus 20 will be described.

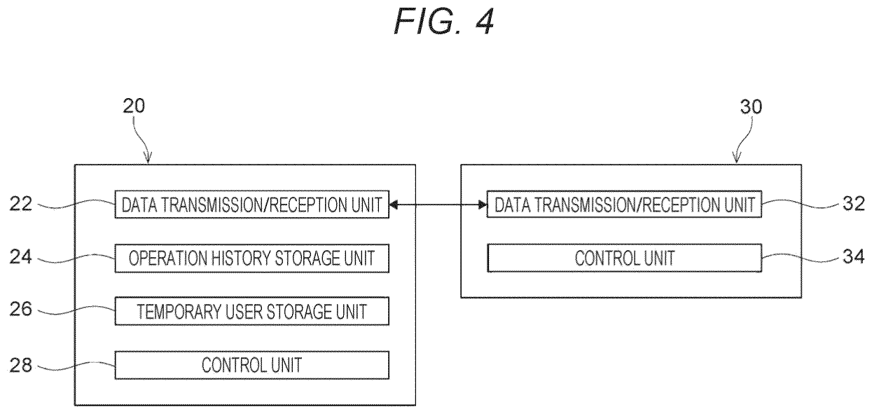

The image processing apparatus 20 realizes various functions using the above-described hardware resources when executing the above-described information processing program. Specifically, as illustrated in FIG. 4, the image processing apparatus 20 functionally includes a data transmission/reception unit 22, an operation history storage unit 24, a temporary user storage unit 26, and a control unit 28.

### (Data Transmission/Reception Unit)

The data transmission/reception unit 22 transmits and receives various kinds of data to and from the operation terminal 30 and the management server 40. The data transmission/reception unit 22 can transmit and receive various kinds of information to and from the operation terminals 30 in accordance with SNMPv3. The data transmission/reception unit 22 is also capable of transmitting a SNMPv3 Trap (event notification) to the operation terminal 30. In the SNMPv3 Trap, encrypted communication (encryption of a message) is enabled as described above.

### (Operation History Storage Unit)

An operation history table for registering the operation history of a user is stored in the operation history storage unit 24. As an example, the operation history table is configured as a MIB (private MIB) of SNMPv3.

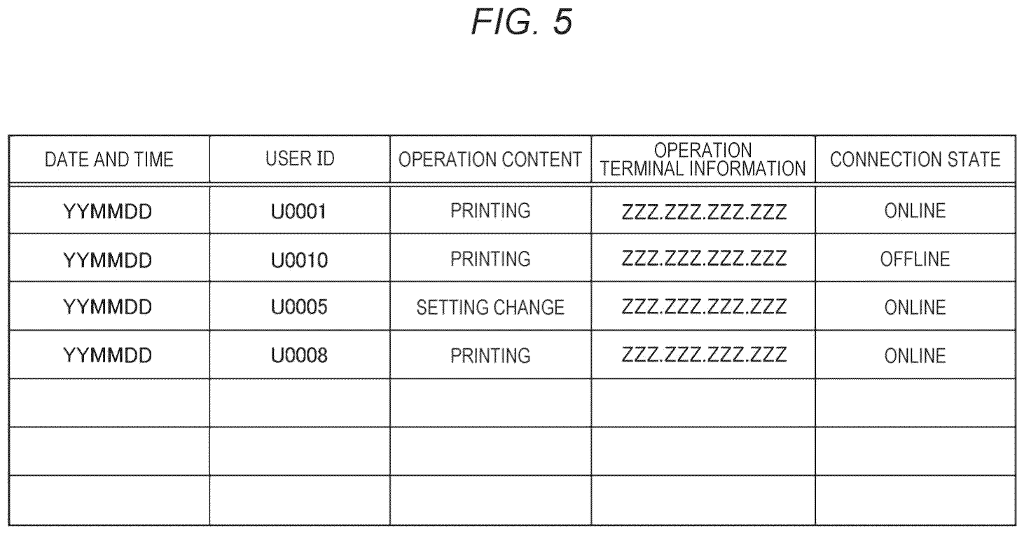

FIG. 5 illustrates an example of the operation history table. As illustrated in FIG. 5, the operation history table includes, as items, operation date and time, user ID, operation content, operating terminal information, and connection state.

The date and time is, for example, the date and time when the image processing apparatus 20 received an operation request from the user. The user ID is identification information for identifying the user of the image processing apparatus 20 and is uniquely determined.

The operation content is a content of the operation of the image processing apparatus 20 operated by the user, and includes, for example, printing, copying, setting change, and the like. The operation authority for printing, copying, and the like is general authority and is given to, for example, general users. On the other hand, the operation authority for the setting change is administrator authority, and is given to, for example, an administrator.

The operation terminal information is address information of the operation terminal 30 operated (held) by the user, and includes, for example, an IP address.

The connection state is information indicating a connection state of the user (the operation terminal 30 held by the user) managed by the management server 40 described above. The connection state is acquired from the management server 40.

### (Temporary User Storage Unit)

The temporary user storage unit 26 stores a temporary user management table for registering information on users who temporarily use the image processing apparatus 20 (hereinafter, referred to as “temporary users”). As an example, the temporary user management table is configured a MIB (private MIB) of SNMPv3.

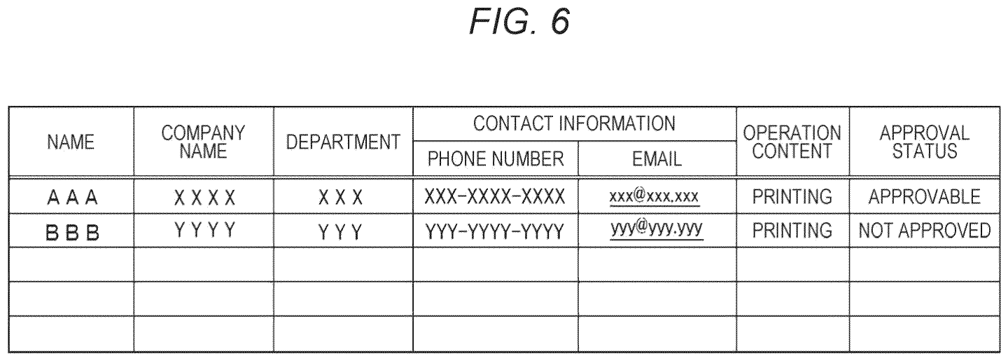

FIG. 6 illustrates an example of the temporary user management table. As illustrated in FIG. 6, the temporary user management table includes, as items, name, company name, department, contact information (phone number, mail address), operation content, and temporary approvable/not approvable.

The name, company name, department, and contact information (phone number, mail address) are individual information of the temporary user. The operation content is an operation content requested by the temporary user, and includes, for example, printing, setting change, and the like. The approval status is information indicating an authentication status of the temporary user for the image processing apparatus 20, and includes, for example, unapproved and approved.

### (Control Unit)

The control unit 28 controls the overall operation of the image processing apparatus 20. The control unit 28 also performs authentication processing for a user to which a user ID is assigned. Specifically, the control unit 28 first receives the user ID and the password of the user input to the input unit 58 of the image processing apparatus 20 as authentication information. Alternatively, the control unit 28 receives the user ID and the password of the user as the authentication information from the operation terminal 30.

Next, the control unit 28 transmits approval request information including the received authentication information to the management server 40, and receives an authentication result from the management server 40. When the authentication result received from the management server 40 indicates successful authentication, the control unit 28 permits the operation of the image processing apparatus 20 in accordance with the operation authority of the user received from the management server 40. On the other hand, when the authentication result received from the management server 40 is authentication failure, the control unit 28 does not allow (prohibits) the operation of the image processing apparatus 20.

The control unit 28 performs operation history storage processing for storing an operation history of the user performed on the image processing apparatus 20. Specifically, when the image processing apparatus 20 is operated by the user, the control unit 28 registers the date and time, the user ID, the operation content, and the operation terminal information in the operation history table (see FIG. 5).

The control unit 28 also performs temporary approval request processing in response to a request from a user to whom the user ID is not assigned (hereinafter, referred to as a “temporary user”). The temporary approval request processing will be described later.

### (Function of Operation Terminal)

Next, functions of the operation terminal 30 will be described.

When executing the above-described information processing program, the operation terminal 30 realizes various functions by using the above-described hardware resources. Specifically, as illustrated in FIG. 4, the operation terminal 30 functionally includes a data transmission/reception unit 32 and a control unit 34.

### (Data Transmission/Reception Unit)

The data transmission/reception unit 32 transmits and receives various kinds of data to and from the image processing apparatus 20 and the management server 40. The data transmission/reception unit 32 can transmit and receive various kinds of information to and from the image processing apparatus 20 in accordance with SNMPv3. The data transmission/reception unit 32 can receive a SNMPv3 Trap (event notification) transmitted from the image processing apparatus 20.

The control unit 34 controls the overall operation of the image processing apparatus 20. The control unit 34 also transmits a user authentication request, a printing request, a setting change request, and the like to the image processing apparatus 20. Further, when receiving approval request information of a temporary user from the image processing apparatus 20, the control unit 34 performs temporary approval processing. The temporary approval processing will be described later.

### (Temporary Approval Request Processing)

Next, the temporary approval request processing with the image processing apparatus 20 will be described.

As described above, the image processing apparatus 20 authenticates a user with a user ID and a password. Thus, for example, the user of the image processing apparatus 20 needs to apply for the use of the image processing apparatus 20 to the administrator of the image processing apparatus 20 and have the administrator issue a user ID in advance.

However, for example, when the administrator of the image processing apparatus 20 is absent or the like, it takes time to issue the user ID. There is also a demand for a temporary user to whom a user ID has not been issued to temporarily use the image processing apparatus 20.

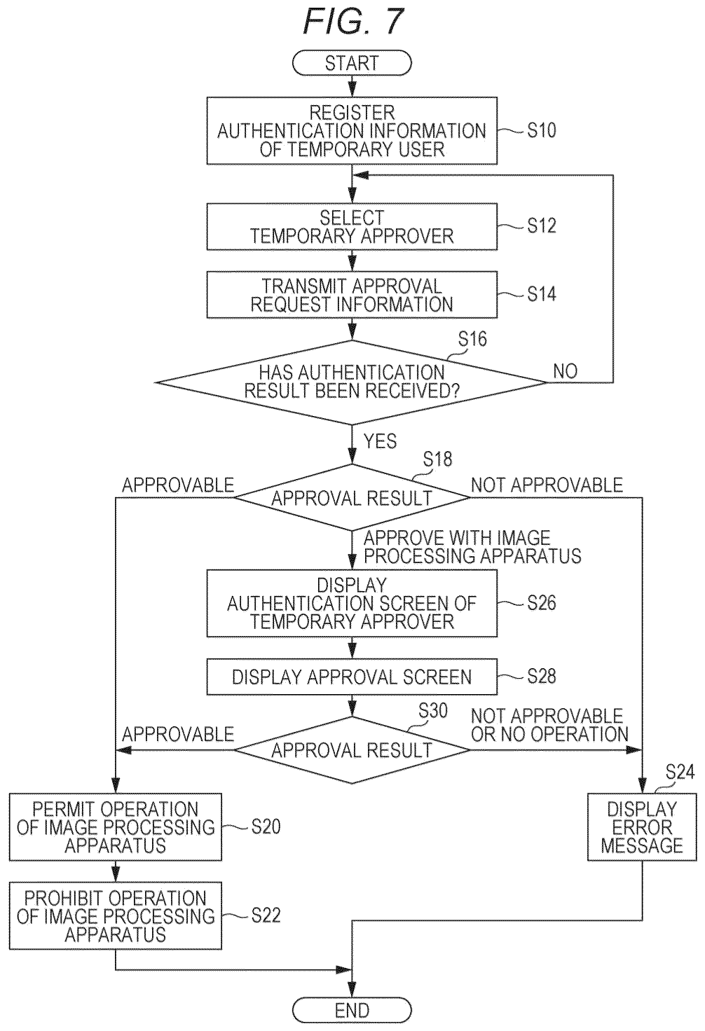

In such a case, temporary approval request processing is performed in the image processing apparatus 20. Specifically, for example, when temporary use (temporary authentication) is selected and authentication information such as a name, a company name, a department, a contact address, and operation content is input in the input unit 58 of the image processing apparatus 20, the temporary approval request processing illustrated in FIG. 7 is executed in the image processing apparatus 20. The temporary approval request processing is an example of a temporary approval request method.

First, in step S10, the CPU 50 registers the authentication information of the temporary user input to the input unit 58 of the image processing apparatus 20 in the temporary user management table (see FIG. 6).

Next, in step S12, the CPU 50 selects an approver (hereinafter referred to as a “temporary approver”) for authenticating the temporary user. At this time, the CPU 50 selects, as the temporary user, a user who has a history in the operation history table (see FIG. 5) and whose connection state is the online state.

Specifically, the CPU 50 extracts the user of the latest history from the operation history table as a first candidate, and inquires of the management server 40 about the connection state of the extracted first candidate. When the connection state of the first candidate received from the management server 40 is the online state, the CPU 50 selects the first candidate as the temporary approver, and updates the connection state of the first candidate in the operation history table to the online state.

On the other hand, when the connection state of the first candidate received from the management server 40 is the offline state, the CPU 50 extracts, as a second candidate, another user (other than the first candidate) having the second latest history from the operation history table, and inquires of the management server 40 about the connection state of the extracted second candidate. When the connection state of the second candidate received from the management server 40 is the online state, the CPU 50 selects the second candidate as the temporary approver and updates the connection state of the second candidate in the operation history table to the online state.

The CPU 50 repeats the above procedure until a temporary approver is selected. When the temporary approver is not selected, for example, the CPU 50 displays a message indicating that the temporary authentication has failed on the display unit 60 of the image processing apparatus 20 and ends the processing.

Next, in step S14, the CPU 50 transmits approval request information to the operation terminal 30 operated by the selected temporary approver. Specifically, the CPU 50 reads, from the operation history table, the operation terminal information of the operation terminal 30 of the temporary approver. Then, the CPU 50 transmits the approval request information of the temporary user to the read operation terminal information (address information) by using a SNMPv3 Trap.

Here, the approval request information includes the authentication information (personal information) of the temporary user. Thus, the CPU 50 transmits the approval request information to the operation terminal 30 of the temporary approver through encrypted communication using a SNMPv3 trap.

The method for selecting the temporary approver can be changed as appropriate. For example, the CPU 50 extracts, as first candidates, a plurality of users who have operation histories in the operation history table within a predetermined time period (e.g., three hours), and inquires of the management server 40 about the connection states of the extracted first candidates. Then, the CPU 50 may select the first candidate whose connection state received from the management server 40 is the online state as the temporary approver. At this time, when there are a plurality of first candidates in the online state, that is, there are a plurality of operation terminals 30 in the online state, the CPU 50 may select, as the temporary approver, the first candidate having the latest operation history.

The CPU 50 may extract, as the first candidate, a user who has a history of the same operation as the operation (operation content) requested by the temporary user in the operation history table. The CPU 50 may extract, as the first candidate, a user who has a history of the operation of a setting change in the operation history table, that is, a user who is granted the operation authority (administrator authority) of the setting change.

Next, in step S16, the CPU 50 determines whether an approval result has been received from the operation terminal 30. Then, when the CPU 50 does not receive an approval result from the operation terminal 30 within a predetermined time, the CPU 50 returns to step S12 and selects another temporary approver.

On the other hand, in step S16, when the CPU 50 has received an approval result from the operation terminal 30 within a predetermined time, the CPU 50 shifts to step S18.

Next, in step S18, the CPU 50 shifts to the next step in accordance with the content of the approval result received from the operation terminal 30. Specifically, when the approval result received from the operation terminal 30 is “approvable”, the CPU 50 shifts to step S20.

Next, in step S20, the CPU 50 enables the operation of the image processing apparatus 20 according to the operation contents (operation request) of the temporary user. At this time, the CPU 50 updates the approval status in the temporary user management table to “approved”, and waits until it reaches a predetermined operation available time. The operation available time is an example of a predetermined condition.

Next, in step S22, when it has reached the operation available time, the CPU 50 restricts (prohibits) the operation of the temporary user and ends the processing. At this time, the CPU 50 updates the approval status in the temporary user management table to “not approved”.

The operation available time may be designated by the temporary approver on an approval screen 92 displayed on the display unit 80 of the operation terminal 30 described later. In the exemplary embodiment, the operation available time is the predetermined condition for prohibiting the operation of the temporary user. However, the predetermined condition is not limited to the operation available time, and it may be, for example, the number of print jobs, the number of printed sheets, the number of operations of the image processing apparatus 20, or the like.

On the other hand, in step S18, when the approval result received from the operation terminal 30 is “authentication failure”, the CPU 50 shifts to step S24.

In step S24, the CPU 50 displays, on the display unit 60 of the image processing apparatus 20, a message indicating that the authentication has failed, and ends the processing.

In step S18, when the approval result received from the operation terminal 30 indicates that the temporary approver approves with the image processing apparatus 20, the CPU 50 shifts to step S26.

Next, in step S26, the CPU 50 displays an authentication screen for authenticating a temporary approver on the display unit 60 of the image processing apparatus 20. On the authentication screen, for example, the user ID and the password can be input. Then, when the user ID and the password are input to the authentication screen, the CPU 50 performs the authentication processing of the temporary approver for the image processing apparatus 20.

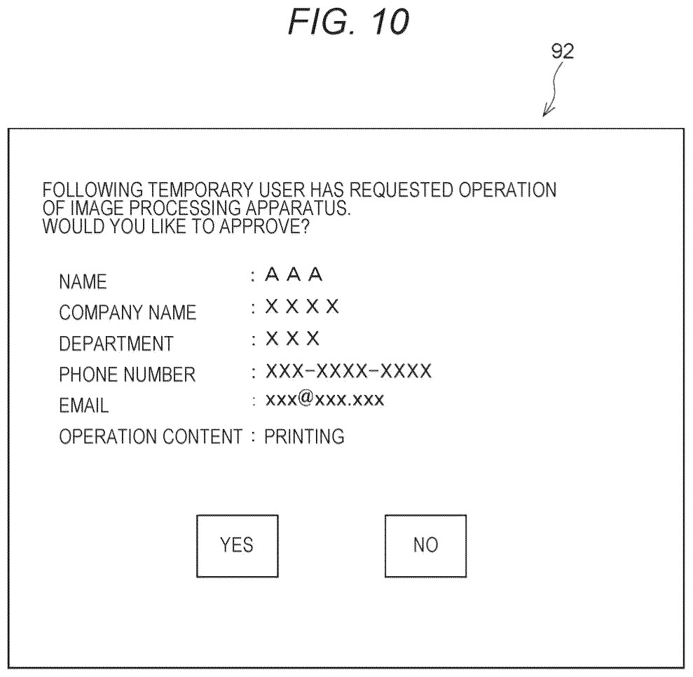

When the temporary approver is authenticated in the image processing apparatus 20, in step S28, the CPU 50 displays an approval screen for selecting whether to approve or not the operation request of the temporary approver on the display unit 60 of the image processing apparatus 20. The approval screen is the same as, for example, the approval screen 92 (see FIG. 10) displayed on the display unit 80 of the operation terminal 30 described later.

Next, in step S30, the CPU 50 shifts to the next step in accordance with the selected option on the approval screen. Specifically, in the approval screen 92, when “approvable” (“YES” button) is selected, the CPU 50 shifts to step S20.

On the other hand, in step S32, when the CPU 50 selects “not approvable” (“NO” button) on the approval screen 92, or when “approvable” or “not approvable” is not selected within a predetermined time, the CPU 50 shifts to step S24.

### (Temporary Approval Processing)

Next, the temporary approval processing with the operation terminal 30 will be described.

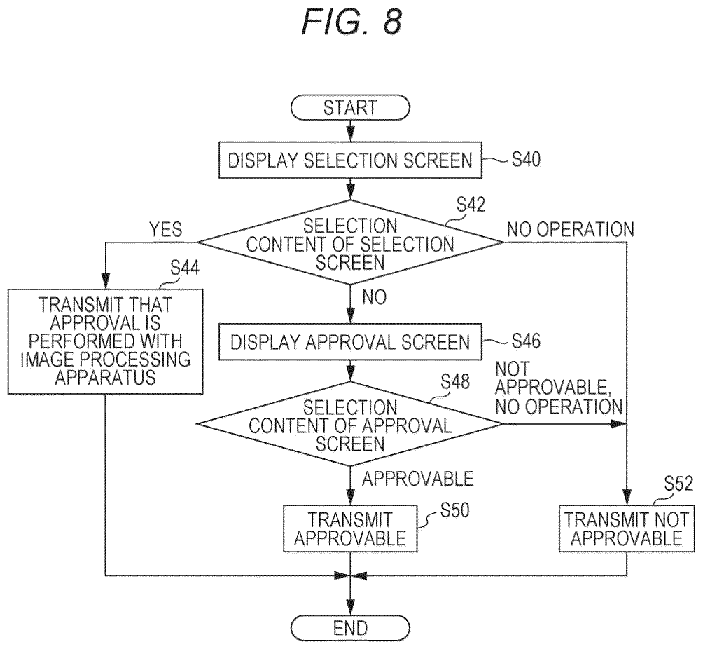

When the operation terminal 30 has received the approval request information from the image processing apparatus 20, temporary approval processing illustrated in FIG. 8 is executed on the operation terminal 30. The temporary approval processing is an example of a temporary approval method.

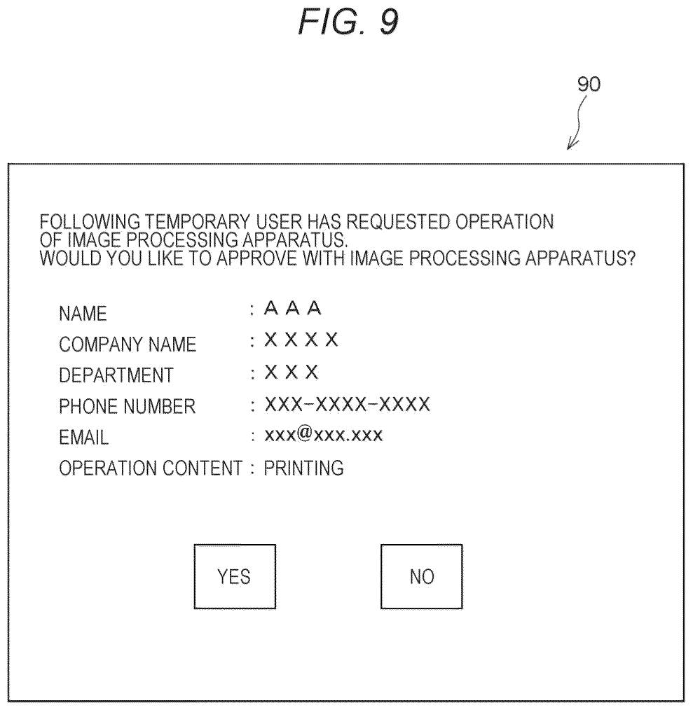

First, in step S40, the CPU 70 displays a selection screen on the display unit 80 of the operation terminal 30 for selecting whether approval of the operation request of the temporary user is performed with the image processing apparatus 20. FIG. 9 illustrates an example of a selection screen 90. For example, the authentication information (personal information) of the temporary user included in the approval request information is displayed on the selection screen 90.

Next, in step S42, the CPU 70 waits until an option is selected on the selection screen 90 and shifts to the next step in accordance with the selected option. Specifically, when it is selected on the selection screen 90 that approval of the operation request of the temporary user is performed with the image processing apparatus 20 (“YES” button), the CPU 70 shifts to step S44.

Next, in step S44, the CPU 70 transmits information indicating that the temporary approver approves the operation request of the temporary user with the image processing apparatus 20 to the image processing apparatus 20, and ends the processing.

On the other hand, when it is selected in the selection screen 90 that the temporary approver does not approve the operation request of the temporary user with the image processing apparatus 20 (“NO” button), the CPU 70 shifts to step S46.

On the selection screen 90, when the option (“YES” button or “NO” button) of the selection screen 90 is not selected within a predetermined time, the CPU 70 shifts to step S52 described later.

Next, in step S46, the CPU 70 displays, on the display unit 80 of the operation terminal 30, an approval screen for selecting whether to approve or not the operation request from the temporary user. FIG. 10 illustrates an example of the approval screen 92. For example, the authentication information (personal information) of the temporary user included in the approval request information is displayed on the approval screen 92.

Next, in step S48, the CPU 70 waits until an option is selected in the approval screen 92, and shifts to the next step in accordance with the selected option. Specifically, in the approval screen 92, when “approvable” (“YES” button) is selected, the CPU 70 shifts to step S50.

When “approvable” (“YES” button) is selected on the approval screen 92, the CPU 70 may allow designation of the operation available time of the temporary user on the approval screen 92.

Next, in step S50, the CPU 70 transmits information indicating that the operation request from the temporary user is approved to the image processing apparatus 20, and ends the processing.

On the other hand, in step S48, when “not approvable” (“NO” button) is selected on the approval screen 92, or when no option is selected on the approval screen 92 within a predetermined time, the CPU 70 shifts to step S52.

In step S52, the CPU 70 transmits information indicating that the operation request from the temporary user is not approved to the image processing apparatus 20 and ends the processing.

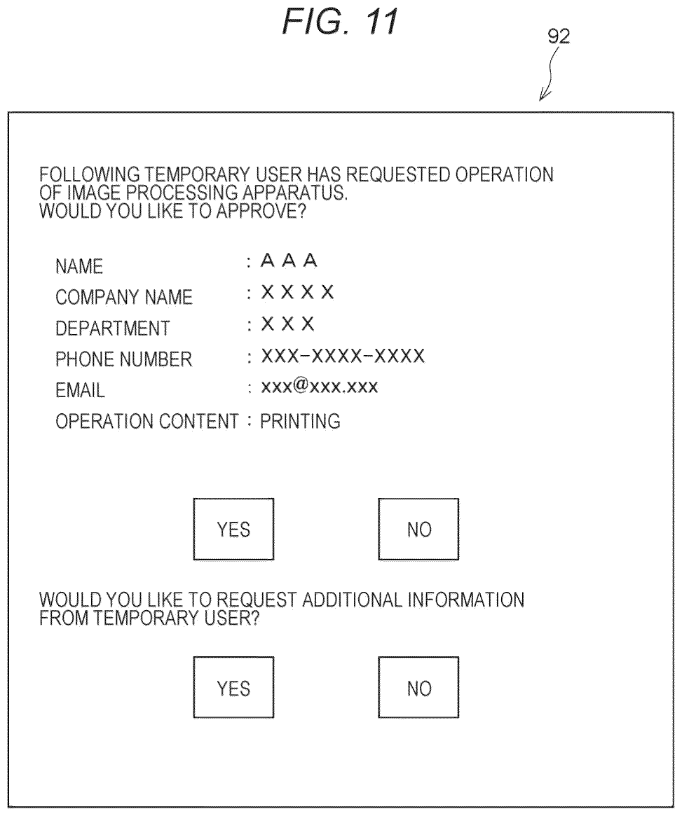

When the temporary user is approved, additional information on the temporary user may be requested to the image processing apparatus 20 with the operation terminal 30. In FIG. 11, as an example, it is possible to select whether additional information relating to the temporary user is necessary on the approval screen 92. Examples of the additional information include image data of a face photograph, a business card, an employee ID card, and the like.

When a request for additional information (“YES” button) is selected in the approval screen 92, the CPU 70 transmits information indicating that additional information is requested, to the image processing apparatus 20.

The CPU 50 of the image processing apparatus 20 that has received the information indicating that the additional information is requested displays, for example, a request message for the additional information on the display unit 60 and makes the image reading unit 64 as the input unit to be operable. Then, the CPU 50 transmits the image data of a face photograph, a business card, an employee ID card, and the like input with the image reading unit 64 to the operation terminal 30 as additional information.

The CPU 70 of the operation terminal 30 that has received the additional information from the image processing apparatus 20 displays the additional information on the display unit, for example.

### MODIFICATION EXAMPLE

Next, a modification example of the exemplary embodiment described above will be described.

In the exemplary embodiment described above, the selection screen 90 and the approval screen 92 can be displayed on the display unit 80 of the operation terminal 30. However, at least one of the selection screen 90 and the approval screen 92 may be displayed on the display unit 80 of the operation terminal 30.

In the exemplary embodiment described above, a temporary user to whom a user ID has not been issued is allowed to temporarily operate (use) the image processing apparatus 20. However, for example, even a user to whom a user ID has been issued does not have operation authority for a specific (partial) operation such as a setting change in some cases. For such a specific operation without operation authority, the image processing apparatus 20 may be allowed to be temporarily operated.

In the exemplary embodiment described above, the approval request information of the temporary user is transmitted from the image processing apparatus 20 to the operation terminal 30 by using a SNMP Trap. However, the approval request information of the temporary user is not limited to SNMP Trap, but may be transmitted from the image processing apparatus 20 to the operation terminal 30 using another communication protocol.

In the exemplary embodiment described above, the processor refers to a processor in a broad sense, including general-purpose processors (for example, CPU: central processing unit) and dedicated processors (for example, GPU: graphics processing unit, ASIC: application Specific integrated circuit, FPGA: field programmable gate array, and programmable logic devices).

The operation of the processor in the exemplary embodiment described above may be performed not only by one processor but also by a plurality of processors that are present at physically distant positions in cooperation with each other. The order of the respective operations of the processor is not limited to only the order described in the exemplary embodiment described above but may be appropriately changed.

Although an example in which each program is installed in a ROM or a storage has been described in the exemplary embodiment described above, the present disclosure is not limited to this configuration. Each program according to the exemplary embodiment described above may be provided in the form of being recorded on a computer-readable storage medium. For example, each program according to the exemplary embodiment described above may be provided in a form of being recorded in an optical disc such as a compact disc (CD)-ROM and a digital versatile disc (DVD)-ROM, or in a form of being recorded in a semiconductor memory such as a universal serial bus (USB) memory and a memory card. Each program according to the exemplary embodiment described above may be acquired from an external device via a communication I/F.

Although a case where the processing in the image processing apparatus 20 and the operation terminal 30 are realized in a software configuration by executing a program on a computer has been described in the exemplary embodiment described above, the present disclosure is not limited to this configuration. For example, the processing in the image processing apparatus 20 and the operation terminal 30 may be realized by a hardware configuration or a combination of a hardware configuration and a software configuration.

The configuration of the image processing apparatus 20 and the operation terminal 30 described in the exemplary embodiment described above is merely an example, and it goes without saying that unnecessary parts may be deleted or new parts may be added without departing from the gist of the present disclosure.

The flow of the processing in the image processing apparatus 20 and the operation terminal 30 described in the exemplary embodiment described above is also an example, and it goes without saying that unnecessary steps may be deleted, new steps may be added, or the processing order may be changed without departing from the gist of the present disclosure.

With respect to the exemplary embodiment described above, the following supplementary notes are further disclosed.

(((1)))

An information processing system comprising a processor,
wherein when the processor has received an operation request from a user for an operation of an image processing apparatus without operation authority, the processor transmits approval request information for the operation request to an operation terminal of the image processing apparatus determined based on an operation history of the image processing apparatus.
   (((2)))

The information processing system according to (((1))
wherein the processor transmits the approval request information to the operation terminal that has a history in the operation history and that is in an online state.
   (((3)))

The information processing system according to (((2))),
wherein when there are a plurality of the operation terminals in an online state, the processor transmits the approval request information for the operation request to the operation terminal having the latest history.
   (((4)))

The information processing system according to any one of (((1))) to (3)
wherein the processor transmits the approval request information to the operation terminal having a history of the same operation as an operation requested by the user in the operation history.
   (((5)))

The information processing system according to any one of (((1))) to (4)
wherein the processor transmits the approval request information to the operation terminal through encrypted communication.
   (6)

The information processing system according to any one of (((1))
wherein when the processor does not receive a response from the operation terminal within a predetermined time after transmitting the approval request information to the operation terminal, the processor transmits the approval request information to another operation terminal of the image processing apparatus determined based on the operation history of the image processing apparatus.
   (((7)))

The information processing system according to any one of (((1))) to (6)),
wherein when the processor has received, from the operation terminal, information indicating that the operation request is approved, the processor enables an operation corresponding to the operation request in the image processing apparatus.
   (((8)))

The information processing system according to (((7))),
wherein, after enabling the operation corresponding to the operation request in the image processing apparatus, the processor prohibits the operation corresponding to the operation request based on a predetermined condition.
   (((9))

The information processing system according to (((8))),
wherein the predetermined condition includes an operation available time of the operation corresponding to the operation request.
   (((10)))

The information processing system according to any one of (((1))) to (9)
wherein when the processor has received a request for additional information on the user from the operation terminal, the processor:
enables an input operation of the additional information in the image processing apparatus; and
transmits, to the operation terminal, the additional information that has been input.
   (((11)))

A non-transitory computer-readable storage medium storing an information processing program for causing a computer to execute processing of, transmitting, when receiving an operation request from a user for an operation of an image processing apparatus without operation authority, approval request information for the operation request to an operation terminal of the image processing apparatus having a history in an operation history of the image processing apparatus.

(((12)))

An information processing system comprising a processor,
wherein when the processor has received, from an image processing apparatus, approval request information for an operation terminal of the image processing apparatus, the approval request information being for an operation request for the image processing apparatus from a user, the processor:
displays, on a display unit of the operation terminal, an approval screen for selecting whether to approve or not the operation request; and
transmits, when approvable is selected on the approval screen, to the image processing apparatus, information indicating that the operation request is approved.
   (((13))

An information processing system comprising a processor,
wherein when the processor has received, from an image processing apparatus, approval request information for an operation terminal of the image processing apparatus, the approval request information being for an operation request for the image processing apparatus from a user, the processor:
displays, on a display unit of the operation terminal, a selection screen for selecting whether to approve the operation request with the image processing apparatus; and
transmits, when it is selected on the selection screen that the approval of the operation of the operation request is performed with the image processing apparatus, to the image processing apparatus, information indicating that the approval of the operation request is performed with the image processing apparatus.
   (((14)))

The information processing system according to (((13))), wherein
when it is selected on the selection screen that the approval of the operation request is not performed with the image processing apparatus, the processor displays an approval screen for selecting whether to approve or not the operation request on the display unit, and
when approvable is selected on the approval screen, the processor transmits information indicating the operation request is approved to the image processing apparatus.
   (((15)))

A non-transitory computer-readable storage medium storing an information processing program for causing a computer to execute processing of:
displaying, wherein when approval request information from an image processing apparatus to an operation terminal of the image processing apparatus has been received, the approval request information being for an operation request for the image processing apparatus from a user, an approval screen for selecting whether to approve or not the operation request on a display unit of the operation terminal; and
transmitting, when approvable is selected on the approval screen, to the image processing apparatus, information indicating that the operation request is approved.
   (((16)))

A non-transitory computer-readable storage medium storing an information processing program for causing a computer to execute processing of:
wherein when approval request information from an image processing apparatus for an operation terminal of the image processing apparatus has been received, the approval request information being for an operation request for the image processing apparatus from a user,
displays, on a display unit of the operation terminal, a selection screen for selecting whether to approve the operation request with the image processing apparatus; and
transmits, when it is selected on the selection screen that the approval of the operation of the operation request is performed with the image processing apparatus, to the image processing apparatus, information indicating that the approval of the operation request is performed with the image processing apparatus.

What is claimed is:

1. An information processing system comprising a processor,
wherein when the processor has received an operation request from a user for an operation of an image processing apparatus without operation authority, the processor transmits approval request information for the operation request to an operation terminal of the image processing apparatus determined based on an operation history of the image processing apparatus.

2. The information processing system according to claim 1,
wherein the processor transmits the approval request information to the operation terminal that has a history in the operation history and that is in an online state.

3. The information processing system according to claim 2,
wherein when there are a plurality of the operation terminals in an online state, the processor transmits the approval request information for the operation request to the operation terminal having the latest history.

4. The information processing system according to claim 1,
wherein the processor transmits the approval request information to the operation terminal having a history of the same operation as an operation requested by the user in the operation history.

5. The information processing system according to claim 1,
wherein the processor transmits the approval request information to the operation terminal through encrypted communication.

6. The information processing system according to claim 1,
wherein when the processor does not receive a response from the operation terminal within a predetermined time after transmitting the approval request information to the operation terminal, the processor transmits the approval request information to another operation terminal of the image processing apparatus determined based on the operation history of the image processing apparatus.

7. The information processing system according to claim 1,
wherein when the processor has received, from the operation terminal, information indicating that the operation request is approved, the processor permits an operation corresponding to the operation request in the image processing apparatus.

8. The information processing system according to claim 7,
wherein, after permitting the operation corresponding to the operation request in the image processing apparatus, the processor prohibits the operation corresponding to the operation request based on a predetermined condition.

9. The information processing system according to claim 8,
wherein the predetermined condition includes an operation available time of the operation corresponding to the operation request.

10. The information processing system according to claim 1,
wherein when the processor has received a request for additional information on the user from the operation terminal, the processor:
enables an input operation of the additional information in the image processing apparatus; and
transmits, to the operation terminal, the additional information that has been input.

11. A non-transitory computer-readable storage medium storing an information processing program for causing a computer to execute processing of, transmitting, when receiving an operation request from a user for an operation of an image processing apparatus without operation authority, approval request information for the operation request to an operation terminal of the image processing apparatus having a history in an operation history of the image processing apparatus.

12. An information processing system comprising a processor,
wherein when the processor has received, from an image processing apparatus, approval request information for an operation terminal of the image processing apparatus, the approval request information being for an operation request for the image processing apparatus from a user, the processor:
displays, on a display unit of the operation terminal, an approval screen for selecting whether to approve or not the operation request; and
transmits, when approvable is selected on the approval screen, to the image processing apparatus, information indicating that the operation request is approved.
